(19) United States
(12) Patent Application Publication
(10) Pub. No.: US 2018/0208107 A1
(43) Pub. Date: Jul. 26, 2018

(54) INTERVEHICLE MESSAGE CENTER SYSTEM

(71) Applicant: Manuela Melton, Hernando, MS (US)

(72) Inventor: Manuela Melton, Hernando, MS (US)

(21) Appl. No.: 15/925,689

(22) Filed: Mar. 19, 2018

Related U.S. Application Data
(60) Provisional application No. 62/448,380, filed on Jan. 19, 2017.

(51) Int. Cl. B60Q 1/50; B60Q 1/26; B60Q 1/30

(52) U.S. Cl. CPC B60Q 1/503; B60Q 1/302; B60Q 1/2696

(57) ABSTRACT

An intervehicle message center system including a message center apparatus including a panel, a plurality of attachment means, functional indicia, and a powerer. The functional indicia may be disposed about a surface area of the panel and configured to provide a visual indicator. The visual indicator includes a plurality of lights powered by the powerer. The plurality of attachment means is configured to attach the elongate member to a vehicle. The apparatus is configured to display a user-selected message.

### CROSS REFERENCE TO RELATED APPLICATION

The present application is related to and claims priority to U.S. Provisional Patent Application No. 62/448,380 filed Jan. 19, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of signs and more specifically relates to visual indicators for vehicles.

### 2. Description of Related Art

The lighting system of a motor vehicle consists of lighting and signaling devices mounted or integrated to the front, rear, sides, and in some cases the top of a motor vehicle. This lights the roadway for the driver and increases the visualization of the vehicle, allowing other drivers and pedestrians to see a vehicle's presence, position, size, direction of travel, and the driver's intentions regarding direction and speed of travel. Driving can be quite stressful, especially in heavy traffic. Becoming impatient and even angry with unknown drivers is easy, especially when they perform irritating driving maneuvers. However, when people know the circumstances of those drivers, whether they are just learning to drive or have slower response times due to age, etc., they may become compassionate and even helpful. Additionally, other drivers may merge between convoy vehicles or funeral processions without paying attention, thus separating individuals in the group. Similarly, when driving, emergencies are indicated by hazard lights. However, there currently isn't any way to effectively communicate an emergency to other drivers, who may become frustrated and angered by what they perceive as erratic driving. Further, commercial vehicles whose functions change from time to time need multiple alerts, information signs, or stickers, forcing drivers to swap out the message for each trip. A suitable solution is desired.

U.S. Pat. No. 4,574,269 to Gregory R. Miller relates to a vehicle communicator. The described vehicle communicator includes a visual communicator for a rear window of a vehicle. The communicator is semi-transparent and adapted to be disposed in the rear window of the vehicle for viewing from outside of the vehicle. The degree of transparency is such as to accommodate normal use of an inside rearview mirror of the vehicle by a driver of the vehicle. The communicator also includes a message display unit including a plurality of light emitting diodes comprising in a matrix arrangement and disposed in a limited discrete portion of the rear window. The light emitting diodes are selectively energizable to emit light in the form of a message. The communicator further includes a message control unit operationally interconnected to the light emitting diodes for selectively energizing the light emitting diodes. The message control unit is programmed to energize the light emitting diodes in any one of a plurality of preselected patterns. With this arrangement, the preselected patterns form messages for viewing from outside of the vehicle upon selective actuation of the message control unit.

### BRIEF SUMMARY OF THE INVENTION

In view of the foregoing disadvantages inherent in the known signs art, the present disclosure provides a novel intervehicle message center system, also known as “The Clement” Intervehicle Message Center. The general purpose of the present disclosure, which will be described subsequently in greater detail, is to provide a safe and convenient way to communicate with other drivers and people outside the vehicle.

An intervehicle message center system is disclosed herein. The intervehicle message center system includes a message center apparatus having a panel, a plurality of attachment means, functional indicia, and a powerer. The panel has an elongate member having a first-side and a second-side. The functional indicia may be disposed about a surface area of the elongate member and configured to provide a visual indicator. The visual indicator includes a plurality of lights powered by the powerer. One of the plurality of attachment means are located on a left-portion of each the elongate member and another of the plurality of attachment means located on a right-portion of each the elongate member. The plurality of attachment means is configured to attach the elongate member to a vehicle. The apparatus is configured to display a user-selected message.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an intervehicle message center system, constructed and operative according to the teachings of the present disclosure.

FIG. 1 is a perspective view of the intervehicle message center system during an ‘in-use’ condition, according to an embodiment of the disclosure.

FIG. 2 is a perspective view of the intervehicle message center system of FIG. 1, according to an embodiment of the present disclosure.

FIG. 3 is a perspective view of the intervehicle message center system of FIG. 1, according to an embodiment of the present disclosure.

FIG. 4 is a perspective view of the intervehicle message center system of FIG. 1, according to an embodiment of the present disclosure.

FIG. 5 is a perspective view of the intervehicle message center system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to signs and more particularly to an intervehicle message center system as used to improve the visual indicator means for vehicles.

Generally, intervehicle message center system provides a safe and convenient way to communicate with other drivers and people outside the vehicle. It flashes or scrolls messages or instructions with bright, solar-powered LED lights. It identifies drivers that present the possibility of driving mistakes, such as beginning and elderly drivers and those using adaptive driving equipment, such as hand controls or left foot accelerators. This serves safety purposes by displaying warnings or instructions on some commercial vehicles. It identifies convoy groups, such as fans traveling together to sporting events, school groups traveling together on field trips, and so forth. This system may not be not integrated with the lighting and signal devices of the vehicle, except to access power. It may use a BLUETOOTH® or wireless technology via a cellphone application or wireless remote.

This innovative product may comprise an unobtrusive, sleek, rectangular LED light in a black matte housing. It may further be weatherproof and may be mounted inside or outside the vehicle. On the top of the light can be a solar panel that charges an internal rechargeable battery that may be accessed via a battery door on the back panel of the device. An optional 12 V cord can be provided in case of prolonged periods of low-light conditions. For low light areas, the device may also be hardwired to a vehicle battery similar to speakers or rear light wires. Additionally, the unit can have adjustable-tilt brackets on each side with strong suction cups (bolts or other suitable fasteners may be used) that hold it to a vehicle's rear window or the vehicle's exterior using strong adhesive, for vehicles that do not have rear windows. The device may also be mounted to other vehicle surfaces both interior and exterior. The brackets allow the device to tilt, accommodating the slant of vehicles' rear windows. The brackets can click to adjust, instead of using wing nuts and bolts.

Further, the display can project a white background with black text during the day and a black background with green text at night or in low light conditions to prevent blinding. Other colors may be used. It can have a number of pre-programmed messages in which drivers can toggle through via open-network technology and a remote control or cell phone application. Users can input their own custom messages; however, the application can be pre-programmed to block rude or obscene words or messages or to disable creating custom messages while driving. The unit may be controlled outside the vehicle because of the open source technology so safety issues may be displayed in emergency situations such as carjacking, to alert that the vehicle is stolen.

The unit might be turned off using the remote control or cell phone application, and it might also include a timer that can be set to turn off after a certain amount of time, ideally the estimated duration of the trip. The display can measure approximately 3″-4″ in height and 18″ in length, although it can be offered in different sizes as needed, according to the size of the vehicle. The message center may sense light changes and change modes at night. The screen can change from white to black with green writing, so it would not be blinding.

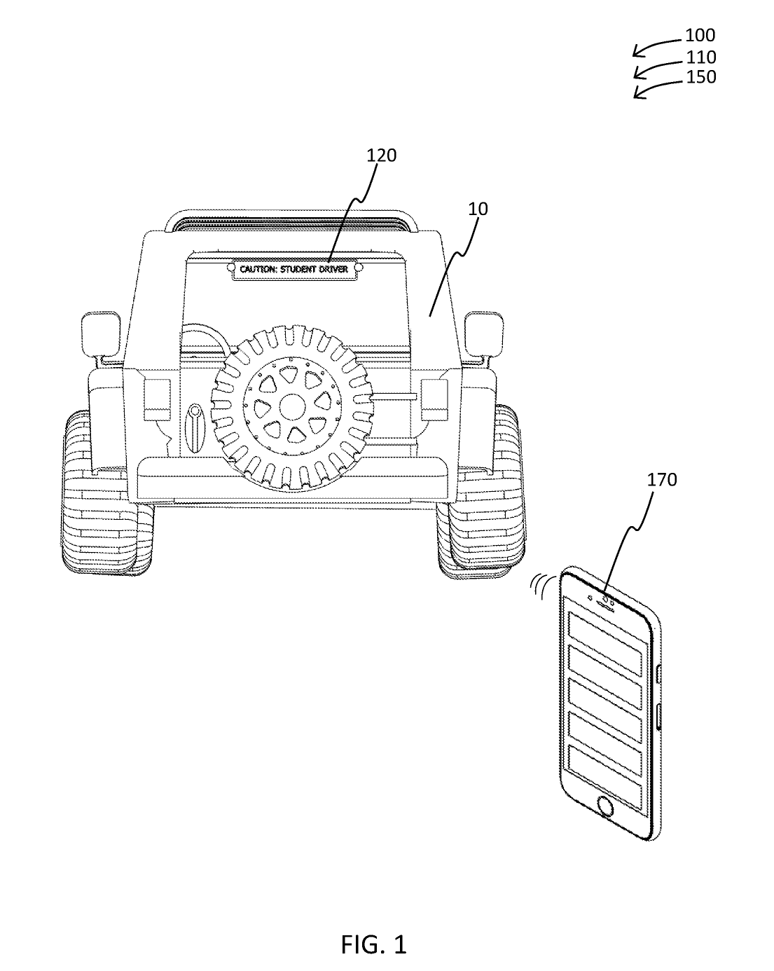

Referring now more specifically to the drawings by numerals of reference, there is shown in FIGS. 1-5, various views of an intervehicle message center system 100. FIG. 1 shows an intervehicle message center system 100 during an ‘in-use’ condition 150, according to an embodiment of the present disclosure. As illustrated, the intervehicle message center system 100 may comprise a message center apparatus 110 including a panel 120, a plurality of attachment means 130, functional indicia 140, and a powerer 160. The panel 120 has an elongate member having a first-side and a second-side. The functional indicia 140 may be disposed about a surface area of the elongate member and configured to provide a visual indicator. The visual indicator includes a plurality of lights 142 powered by the powerer 160. One of the plurality of attachment means 130 are located on a left-portion of each the elongate member and another of the plurality of attachment means 130 located on a right-portion of each the elongate member. The plurality of attachment means 130 is configured to attach the elongate member to a vehicle 10. The apparatus 110 is configured to display a user-selected message.

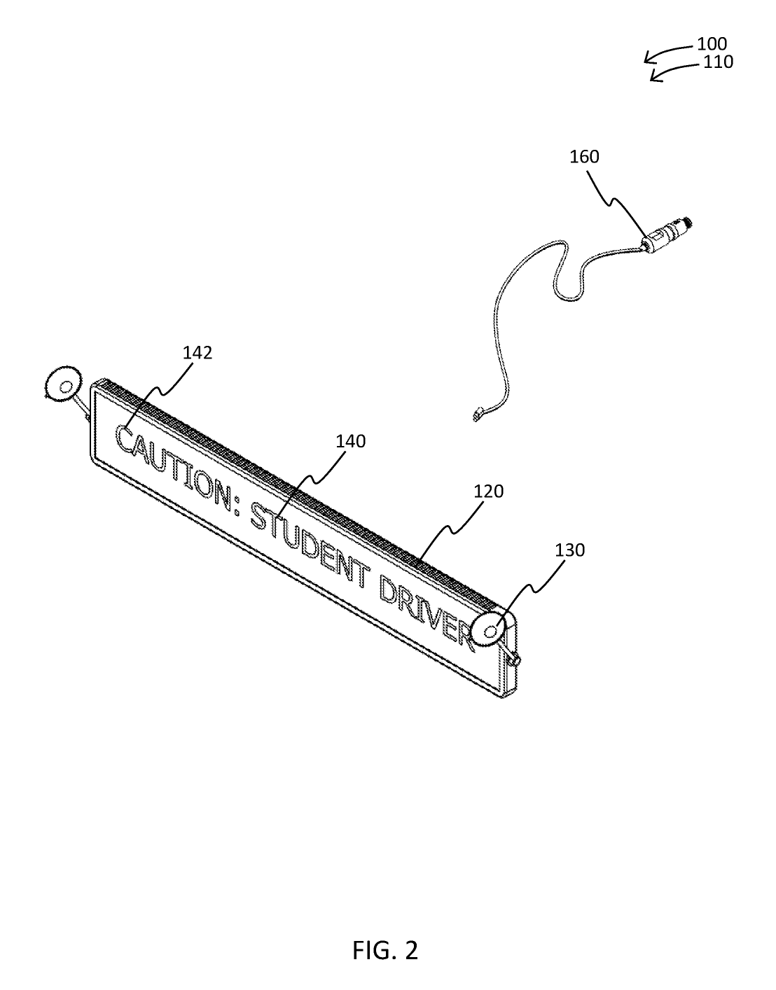

FIG. 2 shows a perspective view of the intervehicle message center system 100 of FIG. 1, according to an embodiment of the present disclosure. As above, the intervehicle message center system 100 may include the message center apparatus 110 including the panel 120, the plurality of attachment means 130, functional indicia 140, and the powerer 160. The message center apparatus 110 is a safety sign configured to be placed on a surface of the vehicle 10 via the plurality of attachment means 130. The surface includes an inside or outside of a window, a door, or body of the vehicle 10. The plurality of attachment means may include suction cups, bolts or other suitable fastening means for securing the message center apparatus 110 to a vehicle 10 at a selected location. The panel 120 comprises a height of approximately 3 to 4 inches and length of approximately 18 inches. Other sizes and variations may be available for smaller or larger vehicles 10.

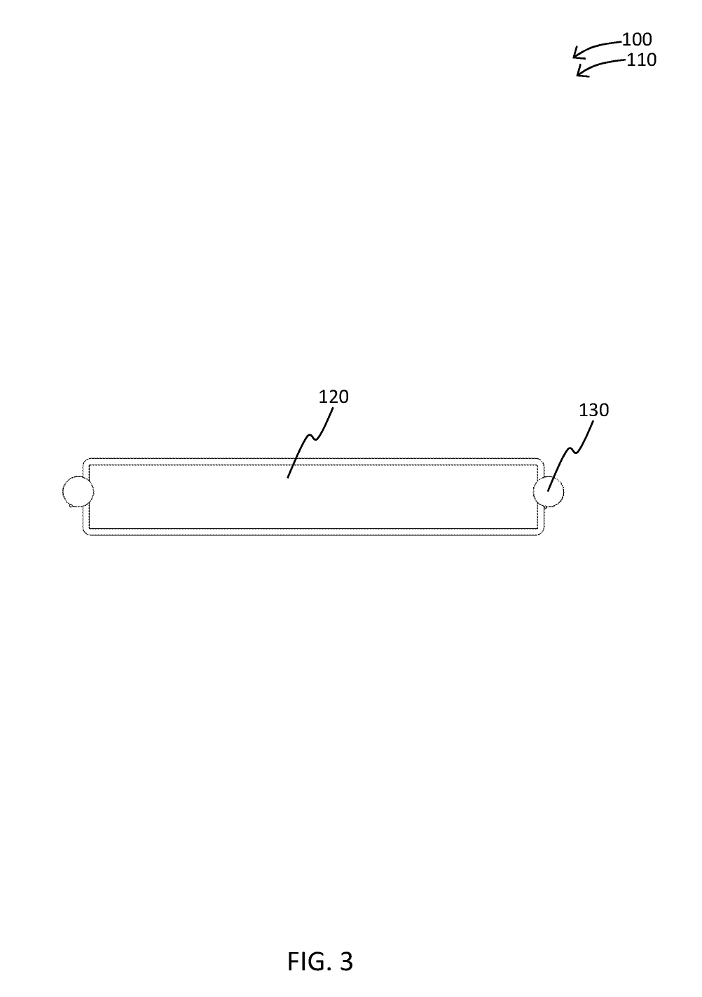

Referring now to FIG. 3 showing a perspective view of the intervehicle message center system 100 of FIG. 1, according to an embodiment of the present disclosure. As above, the intervehicle message center system 100 may include the message center apparatus 110. The message center apparatus 110 comprises a panel 120. The functional indicia 140 is displayed via the plurality of lights 142 on the panel 120. In a preferred embodiment, the plurality of lights 142 are LED-lights. The lights 142 may be solar powered. The message center apparatus 110 further comprises solar panels on the panel. The message center apparatus 110 may use rechargeable batteries charged by solar panels and the batteries may be accessed by a door on the back of the apparatus 110. The LED-lights are adjustable to a desired color. The powerer 160 may include a power cord. The panel 120 is adjustable and tiltable to a desired angle.

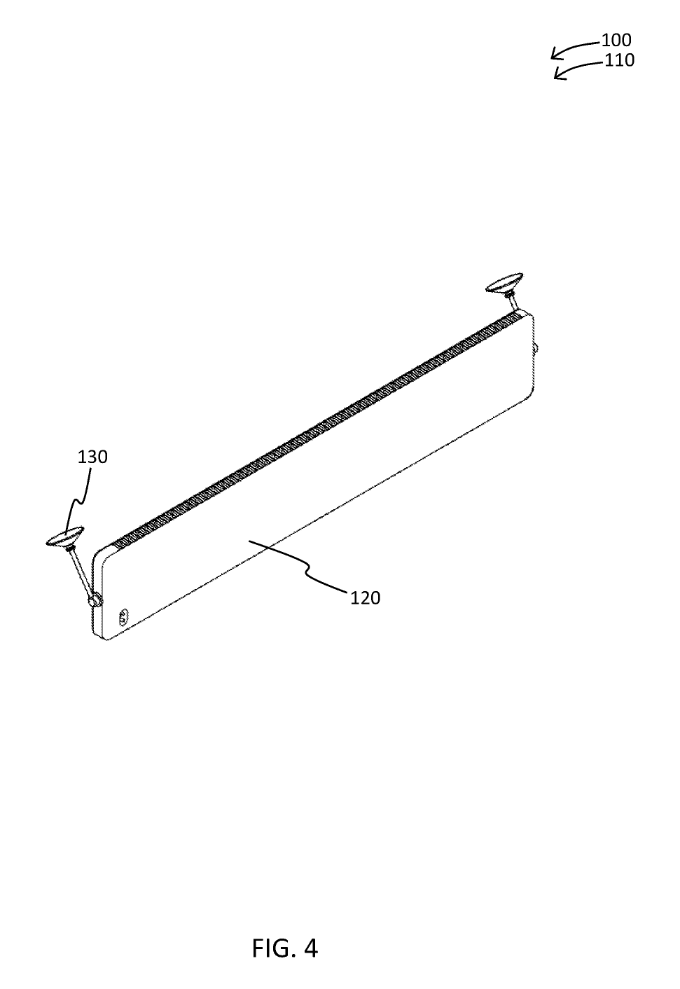

FIG. 4 shows a perspective view of the intervehicle message center system 100 of FIG. 1, according to an embodiment of the present disclosure. As above, the intervehicle message center system 100 may include the message center apparatus 110 including the panel 120, the plurality of attachment means 130, functional indicia 140, and the powerer 160. The apparatus 110 is configured to display a user-selected message. The user-selected message is selected from a set of pre-programmed user-selected messages. The user-selected message may be customizable and censored as needed. The message center apparatus 110 is controlled by a cellphone application or other open network technology control unit 170. The control unit 170 may be a remote control or mobile device in communication with the powerer 160. The message center apparatus 110 further includes timed settings allowing the message center apparatus 110 to be disabled after a predetermined amount of time.

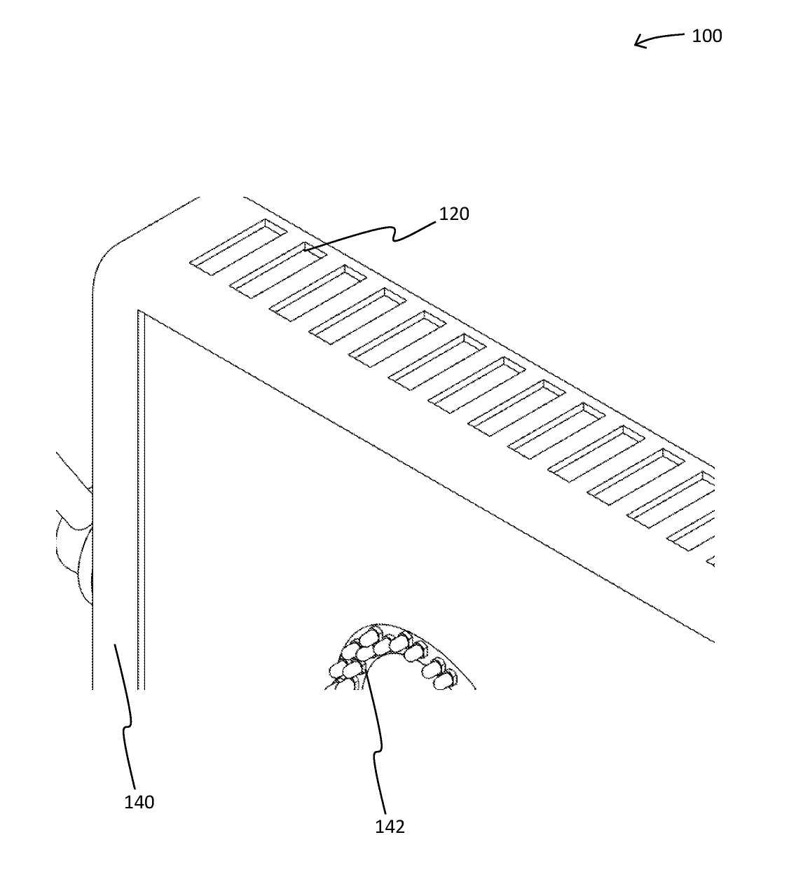

Referring now to FIG. 5 showing a perspective view of the intervehicle message center system 100 of FIG. 1, according to an embodiment of the present disclosure. As above, the intervehicle message center system 100 may include the message center apparatus 110 configured to be secured to a vehicle 10 and display a message. The present invention minimizes probability of accidents or road rage incidents. The intervehicle message center system 100 enables drivers to communicate with other drivers, resulting in safer, more understanding roadway interactions.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An intervehicle message center system comprising:
a message center apparatus including;
a panel;
a plurality of attachment means;
functional indicia; and
a powerer;
wherein said panel has an elongate member having a first-side and a second-side;
wherein said functional indicia is disposed about a surface area of said elongate member and configured to provide a visual indicator;
wherein said visual indicator includes a plurality of lights powered by said powerer;
wherein one of said plurality of attachment means are located on a left-portion of each said elongate member and another of said plurality of attachment means located on a right-portion of each said elongate member;
wherein said plurality of attachment means is configured to attach said elongate member to a vehicle; and
wherein said apparatus is configured to display a user-selected message.

2. The intervehicle message center system of claim 1, wherein said message center apparatus is a safety sign.

3. The intervehicle message center system of claim 1, wherein said message center apparatus is configured to be placed on a surface of said vehicle via said plurality of attachment means.

4. The intervehicle message center system of claim 3, wherein said surface includes a window.

5. The intervehicle message center system of claim 1, wherein said plurality of attachment means includes suction cups.

6. The intervehicle message center system of claim 1, wherein said functional indicia is displayed via said plurality of lights on said panel.

7. The intervehicle message center system of claim 6, wherein said plurality of lights are LED-lights.

8. The intervehicle message center system of claim 7, wherein said lights are solar powered.

9. The intervehicle message center system of claim 1, wherein said message center apparatus further comprises solar panels on said panel.

10. The intervehicle message center system of claim 1, wherein said message center apparatus solar panels charge rechargeable batteries accessed by a door on said message center apparatus.

11. The intervehicle message center system of claim 1, wherein said panel is adjustable and tiltable to a desired angle.

12. The intervehicle message center system of claim 1, wherein said user-selected message is selected from a set of pre-programmed said user-selected messages.

13. The intervehicle message center system of claim 1, wherein said user-selected message is customizable.

14. The intervehicle message center system of claim 1, wherein said message center apparatus is controlled by a control unit.

15. The intervehicle message center system of claim 14, wherein said control unit is a remote control in communication with said powerer.

16. The intervehicle message center system of claim 14, wherein said control unit is a mobile device in communication with said powerer.

17. The intervehicle message center system of claim 1, wherein said message center apparatus further includes timed settings allowing said message center apparatus to be disabled after a predetermined amount of time.

18. The intervehicle message center system of claim 1, wherein said panel comprises a height of approximately 3 to 4 inches and length of approximately 18 inches.

19. The intervehicle message center system of claim 1, wherein said LED-lights are adjustable to a desired color.

20. An intervehicle message center system, the intervehicle message center system comprising:
a message center apparatus including;
a panel;
a plurality of attachment means;
functional indicia; and
a powerer;
wherein said message center apparatus is a safety sign;
wherein said panel has an elongate member having a first-side and a second-side;
wherein said panel is adjustable and tiltable to a desired angle;
wherein said panel comprises a height of approximately 3 to 4 inches and length of approximately 18 inches;
wherein said functional indicia is disposed about a surface area of said elongate member and configured to provide a visual indicator;
wherein said visual indicator includes a plurality of lights powered by said powerer;
wherein said functional indicia is displayed via said plurality of lights on said panel;
wherein said plurality of lights are LED-lights;
wherein said LED-lights are adjustable to a desired color;
wherein said lights are solar powered;
wherein said message center apparatus further comprises solar panels on said panel;
wherein said message center apparatus solar panels charge rechargeable batteries accessed by a door on said message center apparatus;
wherein one of said plurality of attachment means are located on a left-portion of each said elongate member and another of said plurality of attachment means located on a right-portion of each said elongate member;
wherein said plurality of attachment means is configured to attach said elongate member to a vehicle;
wherein said plurality of attachment means includes suction cups;
wherein said message center apparatus is configured to be placed on a surface of said vehicle via said plurality of attachment means;
wherein said surface includes a window;
wherein said apparatus is configured to display a user-selected message;
wherein said user-selected message is selected from a set of pre-programmed said user-selected messages;
wherein said user-selected message is customizable;
wherein said message center apparatus is controlled by a control unit in communication with said powerer; and
wherein said message center apparatus further includes timed settings allowing said message center apparatus to be disabled after a predetermined amount of time.
